(19) United States
(12) Patent Application Publication
(10) Pub. No.: US 2018/0234708 A1
(43) Pub. Date: Aug. 16, 2018

(54) LIVE STREAMING IMAGE GENERATING METHOD AND APPARATUS, LIVE STREAMING SERVICE PROVIDING METHOD AND APPARATUS, AND LIVE STREAMING SYSTEM

(71) Applicant: Seerslab, Inc., Seoul (KR)

(72) Inventor: Jinwook CHONG, Seongnam-si (KR)

(21) Appl. No.: 15/893,705

(22) Filed: Feb. 12, 2018

(30) Foreign Application Priority Data
Feb. 10, 2017 (KR) 10-2017-0018551
Feb. 8, 2018 (KR) 10-2018-0015578

(51) Int. Cl. H04N 21/2187; H04N 21/472; H04N 21/431; H04N 21/643

(52) U.S. Cl. CPC H04N 21/2187; H04N 21/64322; H04N 21/4312; H04N 21/472

(57) ABSTRACT

Provided is a method for generating a live streaming image in a client terminal. The method includes acquiring platform information for generating a streaming image, generating a first streaming image based on the platform information, displaying the first streaming image, selecting, by a user input, at least one of stickers and effects for decorating at least a portion of the displayed first streaming image, and generating a second streaming image by applying the selected at least one of the stickers and effects to the first streaming image in real-time.

### CROSS-REFERENCE TO RELATED APPLICATIONS

This application claims the benefit of priority of Korean Patent Application No. 10-2017-0018551 filed on Feb. 10, 2017 and Korean Patent Application No. 10-2018-0015578 filed on Feb. 8, 2018, all of which are incorporated by reference in their entirety herein.

### BACKGROUND OF THE INVENTION

### Field of the Invention

The present invention relates to an image processing and a service providing method based on a sticker added to a screen or a photograph captured by a camera.

### Related Art

In recent years, broadcasting through the Internet as well as public TV broadcasting and cable TV broadcasting through broadcasting networks have been activated, thereby allowing viewers to experience various broadcasting contents through an Internet Protocol (IP) network. In particular, although broadcasting of a Broadcast Jockey (BJ) who deals with interesting contents is useful in an advertisement effect for a large number of viewers, it is difficult to consider all of these factors in general personal broadcasting. Accordingly, there is a limitation in that the broadcasting of BJ cannot be technically utilized well. In addition, it is difficult for the general personal broadcasting to utilize various broadcasting special effects available in broadcasting stations.

### SUMMARY OF THE INVENTION

The present invention provides a live streaming image generating method and apparatus, a live streaming service providing method and apparatus, and a live streaming system, which allow a Broadcast Jockey (BJ) of a live broadcasting service to provide a much richer media broadcast by utilizing various types of real-time animation stickers and effects, A providing method and apparatus, and a live streaming system.

In an aspect, a method for generating a live streaming image in a client terminal includes: acquiring platform information for generating a streaming image; generating a first streaming image based on the platform information; displaying the first streaming image; selecting, by a user input, at least one of stickers and effects for decorating at least a portion of the displayed first streaming image; and generating a second streaming image by applying the selected at least one of the stickers and effects to the first streaming image in real-time.

The generating of the first streaming image may include: photographing a subject through a camera; and generating the first streaming image based on the photographed subject.

The generating of the second streaming image may include: tracking the subject in real-time to acquire tracking information; and generating the second streaming image by applying the selected at least one of the stickers and effects to the subject based on the acquired tracking information.

The tracking information may include information associated with at least one feature point of the subject, and the selected at least one of the stickers and effects may be applied to the subject via the at least one feature point included in the tracking information.

The information associated with the at least one feature point may include motion information of the at least one feature point, and the selected at least one of the stickers and effects may be applied to the subject in response to a motion of the subject based on the motion information of the at least one feature point.

The method may further include transmitting the generated second streaming image to a live broadcasting server providing a service associated with live broadcasting. Here, the second streaming image transmitted to the live broadcasting server is transmitted to a client terminal of a viewer who watches the live broadcasting.

The platform information may include broadcast platform information associated with live broadcasting acquired from a live broadcasting server providing a service associated with the live broadcasting, and the acquired broadcast platform information may include information on at least one of the stickers and the effects.

The sticker may include a sticker that arbitrarily sets position information in the first streaming image according to a user input to cover a portion of the first streaming image.

The effect may include an effect of allowing at least a portion of the sticker previously applied to the first streaming image to disappear by a user input.

In another aspect, an apparatus of generating a live streaming image includes: a communication unit for communicating with a server; a display unit for displaying a first streaming image generated based on platform information for generating a streaming image acquired from the server through the communication unit; and a controller selecting at least one of stickers and effects for decorating at least a portion of the displayed first streaming image and generating a second streaming image by applying the selected at least one of the stickers and effects to the first streaming image in real-time by a user unit.

In another aspect, a method for providing a live streaming service in a server apparatus providing a live streaming service includes: providing platform information associated with live streaming to a first client terminal; receiving a second streaming image, in which at least one of stickers and effects for decorating at least a portion of the first streaming image generated based on the platform information is applied in real-time, from the first client terminal; and providing the second streaming image acquired from the first client terminal to a second client terminal.

The platform information may include information about at least one of stickers and effects.

The live streaming service may include a live broadcasting service based on the first client terminal, and the second client terminal may be a terminal associated with a viewer who enters a broadcasting station established by the first client terminal.

At least one of a user input at the first client terminal for applying the sticker and a user input at the second client terminal for activating an effect of allowing at least portion of the applied stickers to disappear may be associated with cost payment from at least one of a user account associated with the first client terminal and a user account associated with the second client terminal to the server apparatus.

The at least one of the stickers and the effects may include at least one of stickers and effects associated with advertisement.

when sensing that a user associated with the second client terminal performs an arbitrary action associated with the advertisement based on at least one of stickers and effects associated with the advertisement applied to the streaming image when generating, in the first client terminal, the streaming image by applying at least one of the stickers and effects associated with the advertisement, the method may further include checking advertising-related information corresponding to at least one of the stickers and effects associated with the advertisement applied to the streaming image, and sharing at least a portion of a revenue associated with the advertisement with a user associated with at least one of the first client terminal and the second client terminal based on the confirmed advertisement-related information.

The sharing of revenue associated with the advertisement may be performed by estimating the number of times of application of at least one of stickers and effects associated with an advertisement applied to the second streaming image.

The method may further include providing a sticker/effect selection menu including at least one of sticker candidates and effect candidates applicable at the first client terminal based on the platform information.

At least one of the sticker candidates and the effect candidates included in the sticker/effect selection menu may consider at least one of a history, a content, and a service type of a user associated with the first client terminal and may include at least one of sticker candidates and effect candidates corresponding thereto.

In another aspect, an apparatus for providing a live streaming service includes: a communication unit for communicating with a first client terminal and a second client terminal; and a controller transmitting platform information associated with live streaming provided to the first client terminal through the communication unit, and receiving, from the first client terminal, a second streaming image to which at least one of stickers and effects for decorating at least a portion of the first streaming image generated based on the platform information to provide the second streaming image acquired from the first client terminal to the second client terminal.

### BRIEF DESCRIPTION OF THE DRAWINGS

FIG. 1 is a conceptual view illustrating a live streaming system according to an embodiment of the present invention.

FIG. 2 is a view illustrating a broadcast screen including a streaming image to which a sticker and/or an effect is applied according to a live streaming image generating method according to an embodiment of the present invention.

FIG. 3 is a flowchart illustrating a live streaming image generating method and a live broadcasting service providing method according to an embodiment of the present invention.

FIG. 4 is a conceptual view illustrating broadcast platform information provided from a server to a client terminal.

FIG. 5 is a detailed flowchart illustrating a method of generating a streaming image based on tracking information.

FIG. 6 is a flowchart illustrating a method of applying a sticker associated with an advertisement and sharing an advertising revenue based on the applied sticker.

FIGS. 7A and 7B are conceptual views illustrating examples of various kinds of stickers and effects.

FIG. 8 is a view illustrating a live streaming image generating apparatus according to an embodiment of the present invention.

FIG. 9 is a view illustrating a live streaming image providing apparatus according to an embodiment of the present invention.

FIG. 10 is a view illustrating a live streaming system according to another embodiment of the present invention.

FIG. 11 is a flowchart illustrating a method of generating a streaming image based on a sticker created directly by a user in a live streaming image generating apparatus according to an embodiment of the present invention.

FIG. 12A is a view illustrating a screen of an actual application for implementing a sticker created by a user.

FIG. 12B is a conceptual view illustrating a first embodiment of associating a subject with a sticker design element displayed on the screen of FIG. 12A.

FIG. 12C is a conceptual view illustrating a second embodiment of associating a subject with a sticker design element displayed on the screen of FIG. 12A.

### DESCRIPTION OF EXEMPLARY EMBODIMENTS

Since the present invention may be modified into various types and may be implemented into various embodiments, specific embodiments will be illustrated in the drawings and described in this disclosure in detail.

However, the present invention is not limited to a specific implementation type, but should be construed as including all modifications, equivalents, and substitutes involved in the spirit and the technical scope of the present invention.

The terms such as “a first/the first” and “a second/the second” may be used to describe various components, but the components should not be limited by the terms. The terms are used only in order to distinguish one component from another component. For example, a first component may be named a second component without deviating from the scope of the present invention, and similarly, the second component may be named the first component. The term “and/or” includes a combination of a plurality of related items or any one of a plurality of related items.

It should be understood that when an element is referred to as being “connected” or “coupled” to another element, it may be directly connected or coupled to the other element but another element may also be interposed therebetween. On the other hand, when an element is referred to as being “directly connected” or “directly coupled” to another element, it should be understood that there are no other elements in between.

The terms used herein are used only to describe specific embodiments, and are not intended to limit the present invention. The singular forms “a,” “an,” and “the” include plural referents unless the context clearly dictates otherwise. In this disclosure, the terms “include,” “include,” or “have” specify features, numbers, steps, operations, elements or combinations thereof, but do not exclude existence or addition possibility of one or more other features, numbers, steps, operations, elements or combinations thereof.

Unless described otherwise, all terms used herein including technical or scientific terms may include the same meaning as those generally understood by persons skilled in the art to which the present invention belongs. Terms as defined in dictionaries generally used should be construed as including meanings which accord with the contextual meanings of related technology. Also, unless clearly defined in this disclosure, the terms should not be construed as having ideal or excessively formal meanings.

Hereinafter, exemplary embodiments of the present invention will be described in detail with reference to the accompanying drawings. In order to help the overall understanding of the present disclosure, the same reference numerals will be used for the same elements in the drawings, and a duplicate description of the same elements will be omitted.

Throughout this specification, it will be apparent to those skilled in the art that all stickers/effects mean digitized forms of information for decorating display images, and even when only the term sticker is used, effect may also be considered together.

The live streaming image generating apparatus may be referred to as a client terminal and a live broadcasting streaming image generating apparatus, and the live streaming service providing apparatus may be referred to as a server apparatus and a live broadcasting service providing apparatus. In addition, provision of a selection menu including sticker candidates and effect candidates for application of stickers/effects, application of stickers/effects according to selection in the selection menu, and generation of streaming images based on sticker/effects application may be performed in a client terminal as well as in a server apparatus.

In an embodiment of this specification, the sticker/effect are based on the use for a broadcast service, but is not necessarily used for the broadcast service. The sticker/effect is also applicable to a general communication method. In the broadcast service or other services, the sticker/effect may be utilized as a form of a virtual advertisement of inserting a virtual image with a computer graphic.

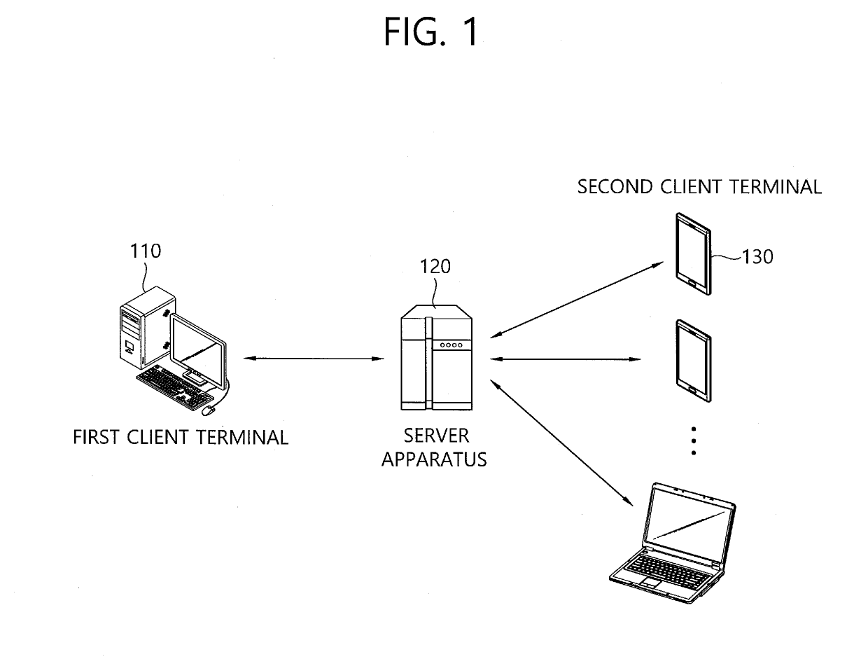

FIG. 1 is a conceptual view illustrating a live streaming system according to an embodiment of the present invention. As shown in FIG. 1, a live streaming system according to an embodiment of the present invention may include a first client terminal 110, a server apparatus 120, and a second client terminal 130.

Referring to FIG. 1, the first client terminal 110 is a terminal of a broadcast jockey that performs streaming in the IP network-based broadcasting system described above. That is, the broadcast jockey receives platform information from the server apparatus 120 to execute the live personal broadcasting, and generates a streaming image associated with the live personal broadcasting to transmit the generated streaming image to the server apparatus 120. The platform information basically includes basic information for generating a streaming image. The platform information may include broadcast platform information. The first client terminal 110 may be called a broadcast jockey (BJ) terminal. The first client terminal 110 creates an environment for personal broadcasting based on the broadcasting platform. The generated environment is basically a video-based broadcasting environment, and may include a form in which a broadcast jockey performs broadcasting as a host. That is, there may be a moving subject such as a person, an animal, or a vehicle, but is not necessarily limited to this form. That is, the first client terminal 110 generates a first streaming image (which may be referred to as a basic streaming image) by photographing a stationary or moving subject based on a photographing unit such as a camera interworking with the first client terminal 110. Alternatively, the first client terminal 110 may generate the first streaming image based on a previously stored image and/or an image received in real-time or non-real-time from another terminal without a special photographing unit.

The first client terminal 110 may enrich the broadcast contents of the broadcast jockey using various broadcast-related control units existing in the broadcast platform. The units for enriching broadcast contents may include stickers and/or effects. The sticker comprehensively means designs and elements associated with the designs for decorating at least a portion of a subject photographed by a camera and displayed on the display unit, a display image containing the subject, and/or the first streaming image generated based on the platform information. For example, the sticker may include designed objects such as fur hat shape, crown shape, eyeglass shape, headband shape, various figures, animation shapes, etc., which are overlaid on the subject. The sticker may exist at a specific position in the image while not moving in non-association with the subject, or may exist in a form moving in accordance with the movement of the subject in association with the subject. In addition, the sticker may include a moving sticker like an animation and an immobile stationary sticker, and may include a sticker implemented with 3D. The sticker may be used as a form of being continuously applied when the sticker/effect is selected, and may also be used as a form of expressing certain emotions and disappearing. The effect may include at least one of a sound-based audio effect, a subtitle, a text, a graphic, a sound, a functional graphic that can call a specific animation, and a video. The stickers and effects may be applied at the same time, and a plurality of stickers and effects may be applied.

The first client terminal 110 selects a sticker and/or an effect to be applied to the first streaming image from a plurality of sticker candidates and/or effect candidates. Here, the sticker candidates and effect candidates may refer to selectable stickers/effects stored in a sticker storage (or inventory) before being selected as an actually applied sticker/effect. The sticker candidates and effect candidates are displayed on the sticker/effect selection menu screen, and at least one of sticker/effect sets including the displayed sticker candidates and the effect candidate may be selected and applied to at least a portion of the display image (first streaming image). A second streaming image is generated based on the applied sticker and/or effect. The generated second streaming image is provided to the server apparatus 120. The first client terminal 110 may together transmit the basic streaming image (first streaming image) to which the sticker/effect is not applied and the second streaming image to which the sticker/effect is applied to the server apparatus 120.

The server apparatus 120 is a terminal that hosts a live broadcasting service. The server apparatus 120 receives the streaming image from the first client terminal 110 executing the personal broadcasting and broadcasts the streaming image to an unspecified number of the second client terminals 130. The server apparatus 120 may manage basic broadcast platform information for broadcasting as well as transmission of the broadcast data. The broadcasting may be implemented through an application or other software programs, and the broadcast platform information includes installation and management information of the application or software programs. The server apparatus 120 occupies a specific Uniform Resource Locator (URL), and allocates a part of the occupied URLs in response to a request from the first client terminal 110 that intends to perform personal broadcasting to allow a broadcasting station to be established through the corresponding channel. In addition, the server apparatus 120 allows other users (viewers) to enter the established broadcasting station, thereby supporting the smooth broadcasting between the broadcast jockey and viewers.

According to an embodiment of the present invention, the broadcast platform information includes information related to the sticker and/or the effect. The broadcast platform information may also include policy information that is related to the calculation of the advertising revenue associated with the sticker and/or effect and the distribution of the calculated advertising revenue.

The second client terminals 130 are terminals of viewers which are connected to the server apparatus 120 and enter a plurality of personal broadcasting stations (including a broadcasting station opened by the first client terminal 110) managed by the server apparatus 120 to enjoy broadcasting. The second client terminal 130 may enter URL-based personal broadcasting stations provided by the server apparatus 120 and allow viewers to view the streaming images provided by the first client terminal 110. In this case, data may be exchanged between a plurality of viewers and the broadcast jockey using the chat window provided by the server apparatus 120. In addition, the second client terminal 130 may allow a viewer to view various advertising contents derived from the stickers and/or effects applied to the streaming image during broadcasting, and may perform a role of creating advertisement-related profits such as purchase of related products.

In an embodiment, at least one of the first client terminal 110 and the second client terminal 120 user terminal may be referred to as a Mobile Station (MS), a User Equipment (UE), a User Terminal (UT), a wireless terminal, an Access Terminal (AT), a terminal, a fixed or mobile subscriber unit, a Subscriber Station (SS), a cellular phone, a wireless device, a wireless communication device, a Wireless Transmit/Receive Unit (WTRU), a mobile node, a mobile, a mobile station, a Personal Digital Assistant (PDA), a smart phone, a laptop, a netbook, a personal computer, a wireless sensor, Consumer Electronics (CE) or other terminologies. Various examples of the terminals may include cellular phones, smart phones having a wireless communication function, Personal Digital Assistants (PDAs) having a wireless communication function, wireless modems, portable computers having a wireless communication function, photographing devices such as digital cameras having a wireless communication function, game devices having a wireless communication function, music storage and playback home appliances having a wireless communication function, Internet home appliances capable of wireless Internet access and browsing, and portable units or terminals incorporated with combinations of such functions, but are limited thereto.

According to another embodiment of the present invention, the first client terminal 110 may not use only a subject currently photographed through a camera as a source image, but may also uses an existing streaming or recorded video as a source to apply stickers/effects. For example, a sticker may be applied even when a streaming image being broadcasted by another terminal is relayed.

Also, a sticker/effect may be applied to a terminal of a viewer like the second client terminal 130, and then may be provided to another client terminal.

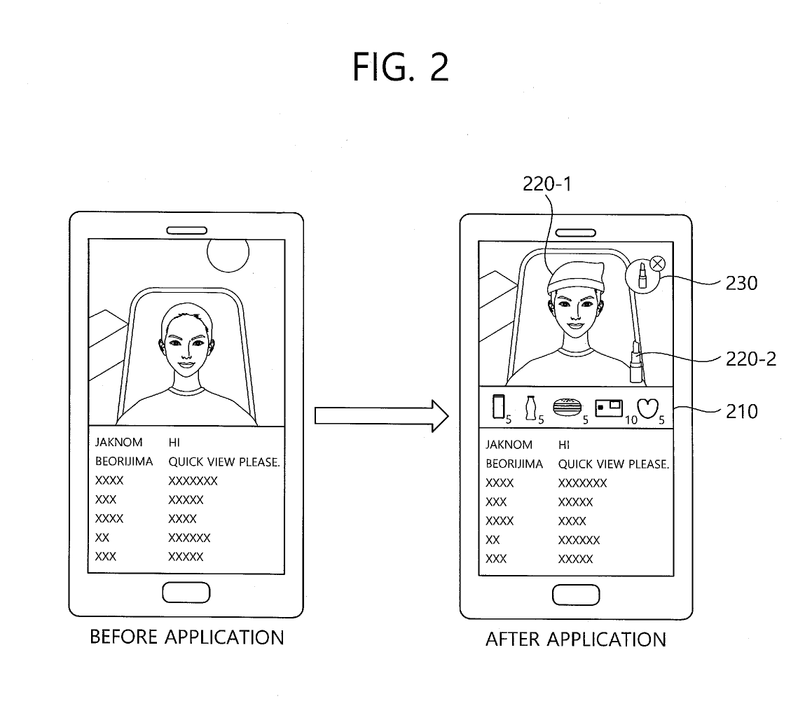

FIG. 2 is a view illustrating a broadcast screen including a streaming image to which a sticker and/or an effect is applied according to a live streaming image generating method according to an embodiment of the present invention.

Referring to FIG. 2, a broadcast jockey may perform personal broadcasting through the first client terminal. The broadcasting may be performed on the basis of an image, and may be performed on a desktop device such as a mobile device or a PC. In the broadcast screen, the broadcast screen includes a portion in which the streaming image is displayed, a chat window portion, and a portion in which chat messages are written. In this case, the broadcast jockey may apply a sticker and/or an effect to the streaming image.

The left drawing of FIG. 2 is a screen before applying a sticker and/or an effect, and the right drawing of FIG. 2 is a screen to which a sticker and/or an effect are applied. When entering a sticker/effect application menu to apply a sticker and/or an effect, a sticker/effect-related menu 210 is displayed. In this case, the selection menu 210 for applying a sticker and icons for entering the selection menu 210 may be allowed to be displayed only on the first client terminal interface separately from the viewers' screens. Here, various kinds of stickers/effects acquired from the server apparatus are displayed. Numbers may be displayed around the sticker/effect. This is related to the amount that can be earned from advertising revenue when the corresponding sticker/effect is used. That is, when a sticker associated with a specific brand, which is marked as a number “10”, is used, a user of the first client terminal (i.e., broadcast jockey) may acquire 10 points of advertising revenue from the corresponding brand. In this case, 10 points may be converted into a value of KRW 1,000, KRW 10, or KRW 100 according to a predetermined point-KRW exchange standard. According to an embodiment of the present invention, there may be a policy that the advertising revenue-related points are acquired once the corresponding sticker/effect is used, and there may be a policy that a user of the first client terminal acquires the corresponding points when a sticker/effect is applied to the live broadcasting streaming image through the use of the sticker/effect and there is a secondary action using the applied sticker/effect in the second client terminal (viewer) that views the applied sticker/effect. For this, monitoring of the secondary action at the second client terminal may be performed.

Referring to the right drawing of FIG. 2, a broadcast jockey may apply a general sticker 220-1 (sticker different from advertisement-purpose sticker) of a fur hat shape to decorate himself/herself. In this case, for example, an effect including snow and a snowman for representing winter may be applied to the bottom of the displayed image (first streaming image) at the same time as the sticker 220-1. Here, a lipstick sticker 220-2 of a specific brand may be selected and applied to be displayed at a specific position on the screen. The lipstick sticker 220-2 of a specific brand, which is an advertisement-purpose sticker, may trigger to display relevant advertising contents and/or relevant advertising links in a circular shape 230 at the top right of the screen. The broadcast viewer may view the sticker displayed in the live broadcasting streaming image of the broadcast jockey or the advertising contents and/or links associated with the sticker, and may click the surroundings to jump to a page that introduces products associated with the advertisement. In this case, the server apparatus may detect the secondary action of a viewer on the sticker, and may distribute the points corresponding to each action to the broadcast jockey. The secondary action may be divided into shopping actions through the web such as purchase of products, product tour, addition to shopping cart, and the like, and the divided actions may have points matching each action. Also, the server recognizes the products associated with such advertisements and the viewer's actions on the products, and allows the broadcast jockey to share compensation for such actions. The compensation may be shared not only with the broadcast jockey but also with viewers who enter the broadcast station.

According to an embodiment of the present invention, a specific sticker/effect included in the sticker/effect menu provided through the server apparatus may include a plurality of sticker elements. That is, when one sticker is clicked and applied to a broadcast streaming image, the lip shapes of 10 or more may be displayed on the whole screen. That is, one sticker may include a plurality of sticker elements, and a first sticker element is disposed at a first position and a second sticker element is disposed at a second position. Thus, a sticker in which the sticker elements are disposed on the whole screen may be utilized. The server apparatus may include and hold the information associated with such a sticker/effect in the broadcast platform information, and the first client terminal that acquires the broadcast platform information and performs broadcasting may also hold the information associated with the sticker/effect.

According to an embodiment of the present invention, the broadcast streaming image is generated at the first client terminal. In some cases, with regard to the application of the sticker/effect, the server apparatus may also generate a streaming image to which the sticker/effect is applied. That is, after a basic streaming image is generated by photographing a subject with a camera or is generated based on an image pre-stored or received from other terminals in the first client terminal, when the basic streaming image is transmitted to the server apparatus and a signal related to the selection of a sticker/effect is provided from the first client terminal to the server apparatus, the server apparatus may parse the signal related to the selection of the sticker/effect to apply the selected sticker/effect to the basic streaming image, and may again transmit the applied streaming image to the first client terminal and/or the second client terminal for broadcasting.

According to another embodiment of the present invention, the sticker/effect information included in the sticker/effect selection menu, which is included in the broadcast platform information and provided to the first client terminal, may be differently provided in accordance with the identification information (e.g., a user account of a broadcast jockey) of a user (i.e., broadcast jockey) of the first client terminal. That is, when a first user pursues a personal broadcasting related to music, a sticker/effect set including a plurality of stickers/effects associated with music may be provided as a selection menu. Alternatively, when the first user pursues a personal broadcasting related to food, a menu including a plurality of sticker/effect sets associated with affiliates various foods/desserts and income dividend may be provided. In other words, the sticker/effect information may be differently generated in consideration of the broadcasting characteristics of a user, and the sticker/effect information thus generated may be included in the broadcast platform information and provided to the first client terminal. In addition, different sticker/effect sets may be provided in accordance with IP and service type of the first client. In order to provide these customized stickers/effects, the data related to the user's broadcast or the histories related to the use of the stickers/effects may be stored in the server apparatus, and the server apparatus may provide the customized stickers/effects to the first client terminal through various statistics algorithms based on the stored data.

According to another embodiment of the present invention, a function of analyzing texts used in the chat window and/or comments used by a broadcast jockey during broadcasting and automatically displaying a screen for selecting a sticker/effect corresponding to the analyzed texts and/or comments may be added. This may be accomplished by pre-storing specific texts and comments in the server apparatus and automatically popping up a menu for selecting the sticker/effect corresponding thereto when the stored text and comments are recognized.

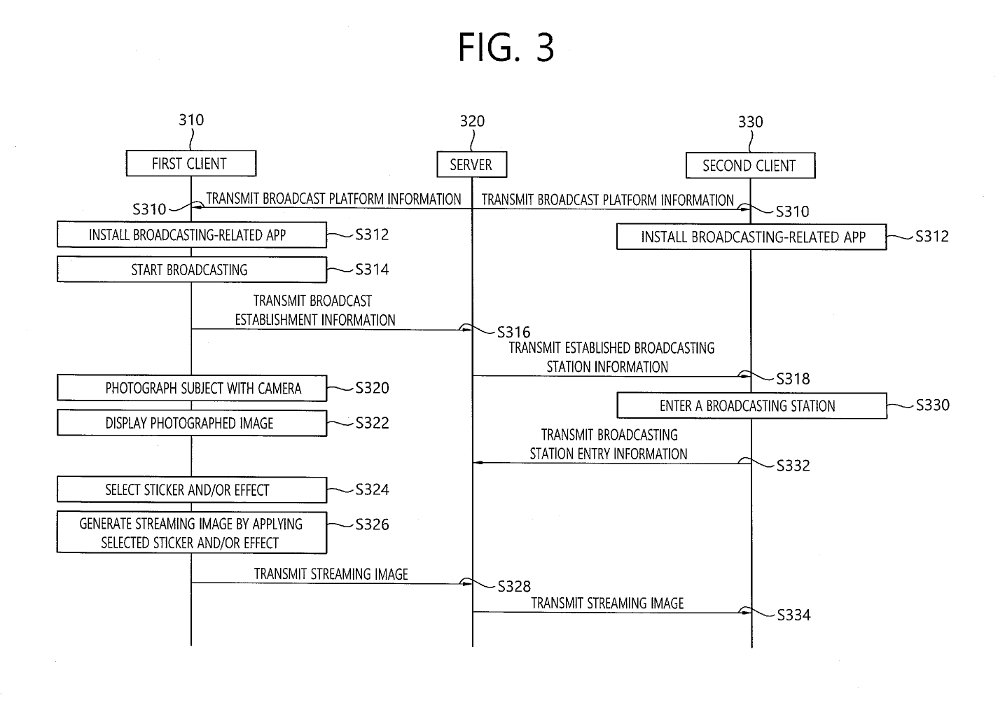

FIG. 3 is a flowchart illustrating a live streaming image generating method and a live broadcasting service providing method according to an embodiment of the present invention.

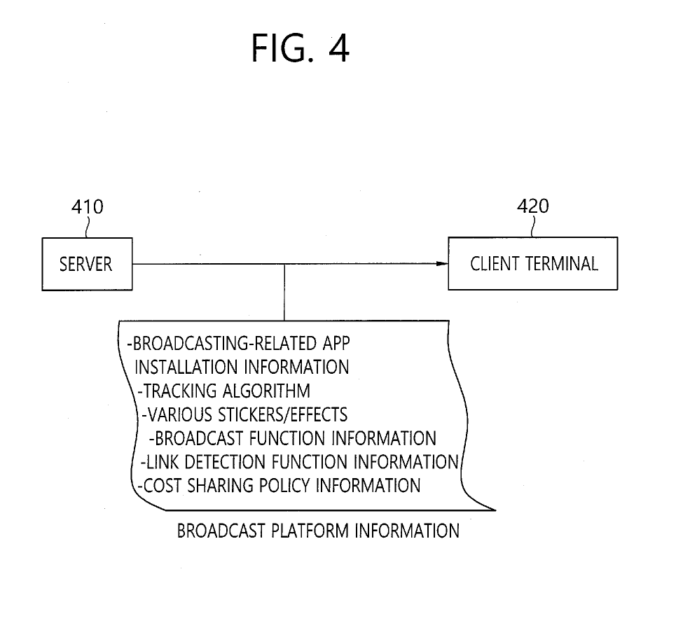

Referring to FIG. 3, in generating a live broadcasting streaming image, firstly, a first client terminal 310 acquires broadcast platform information from a server apparatus 320 (S310). In this case, a second client terminal 330 participating in the broadcasting as a viewer may also acquire the broadcast platform information from the server apparatus 320 (S310). The broadcast platform information includes various kinds of information for broadcasting. This will be described in more detail with reference to FIG. 4.

FIG. 4 is a conceptual view illustrating broadcast platform information provided from a server to a client terminal.

Referring to FIG. 4, platform information is provided from a server 410 to a client terminal 420. The client terminal 420 may include a first client and/or a second client. The platform information includes information for installing an application or a program associated with streaming in the terminal. The platform information may include broadcast platform information. The broadcast platform information includes information for installing an application or a program related to broadcasting in the terminal. Accordingly, the terminal is installed with an application/program that enables broadcasting on the terminal based on the information.

The platform information includes a tracking algorithm. The tracking algorithm includes a face tracking algorithm. That is, the tracking algorithm is an algorithm that acquires information for tracking the motion of a moving subject. The tracking algorithm specifies at least one feature point of a specific subject (e.g., a face, or mouth, nose or the like of face) to which a specific sticker is applied, and includes an algorithm that acquires information (e.g., movement of coordinates) related to the movement of at least one specified feature point. Based on the tracking algorithm, the movement of the moving subject is detected, and the movement distance of the sticker corresponding to the detected movement distance is calculated. Then, the sticker/effect is moved by the calculated moving distance, thereby allowing the sticker/effect to move according to the motion of a subject as well. However, since the tracking may or may not be required according to the characteristics of each sticker, it is desirable that the movement of the sticker according to the tracking information is applied corresponding to the characteristics of the sticker.

The platform information includes various kinds of sticker/effect information. The platform information includes all customized sticker/effect set information for each user and service as well as sticker/effect information stored in the server apparatus. This sticker/effect information is continuously updated as new information associated with the sticker/effect is generated. Also, as the statistical analysis such as the use history of a user is performed, the update is continuously performed. The platform information including the updated sticker/effect information may be periodically provided to each terminal. Also, the sticker/effect information includes information related to the activation of the sticker/effect selection menu corresponding to the detection of a specific text or a specific comment according to voice recognition. In addition, according to another embodiment of the present invention, in regard to the broadcast platform information, the sticker/effect set may be configured based on the advertising sticker/effect associated with or corresponding to the corresponding location based on the location information of the first client terminal. That is, a broadcast jockey at a specific location may transmit broadcast platform information including an advertising sticker/effect set corresponding to the specific location preset in the server to a broadcast jockey such that the location-based sticker/effect can be applied to the streaming image.

Alternatively, according to another embodiment of the present invention, a specific advertising sticker may be applied to a predetermined position based on the location of a viewer, i.e., the second client terminal. The location-based sticker may be directly applied to the broadcast streaming image received at the second client terminal. Alternatively, the location-based sticker may be applied to a streaming image relayed from the second client terminal to a third client terminal.

The broadcast platform information includes various kinds of functional information for broadcasting. The functional information may include information such as chatting, screen layout, and management of viewers of each broadcasting station.

The broadcast platform information includes link sensing function information, which represents information related to a function of sensing actions of a viewer who responds to the sticker/effect and uses advertising products, advertising contents, or advertising links associated therewith. In other words, since the viewer's secondary actions are used as an important factor in the distribution of advertising revenue, an algorithm for sensing the secondary actions may be importantly utilized.

The broadcast platform information includes policy information related to cost sharing. This represents information related to the policy related to the use of the sticker/effect in the broadcasting. For example, the policy information may include detailed policy information on whether or not points can be obtained only by using a specific sticker and whether or not points can be obtained when there is an action of a viewer associated with a specific sticker.

Various kinds of information related to the streaming and/or broadcasting and information related to use of the sticker/effect in streaming and/or broadcasting are included in the platform information and provided to the client terminal 420.

Referring again to FIG. 3, the first and second client terminals 310 and 330 that acquire the platform information install the streaming and/or broadcast-related application/program (S312). Then, the first and second client terminals 310 and 330 run the installed application/program.

First, in an embodiment of streaming associated with broadcasting, the first client terminal 310 establishes a broadcasting station to start personal broadcasting (S314). In this case, broadcasting establishment information for informing the broadcasting establishment is transmitted to the server 320 together with the broadcasting establishment. The broadcast establishment information may include information such as a user account associated with the first client terminal 310, a total number of available viewers, and a content type. The broadcasting establishment information may be provided to terminals of viewers who desire to enter the broadcasting station, that is, the second client terminal 330 (S318). This may be performed in response to a request from the second client terminal 330. When the information of the currently opened broadcasting station is requested, the information of the opened broadcasting stations is provided in response thereto. The second client terminal 330 may enter a broadcasting station selected from the established broadcasting stations that are provided by itself (S330).

The first client terminal 310 that has opened the broadcasting may photograph a subject using a camera interworking with the terminal or a camera included in the terminal (S320). In this case, the subject may be anything as well as a user himself or herself. Then, the photographed image may be displayed through the display unit of the terminal (S322). The display screen of the photographed subject is streamed and broadcast. If a user desires to apply stickers and/or effects during the broadcasting, then a user clicks an icon that pops up the menu window for selecting stickers and/or effects through the user interface. Then, various stickers/effects included in the broadcast platform information are displayed on the screen. In this case, a sticker/effect set corresponding to information on the user's account, the type of the terminal, and the content type of the established broadcasting station may be generated and provided in a customized manner. The first client terminal 310 selects at least one of the provided sticker/effect sets (S324). The selected sticker/effect is applied to at least a portion of the display image including the moving subject to be generated into a streaming image (S326). The streaming image to which the sticker/effect is applied is transmitted to the server 320 (S328), and the server 320 provides the streaming image to all the viewer terminals 330 that enter the broadcasting station (S334).

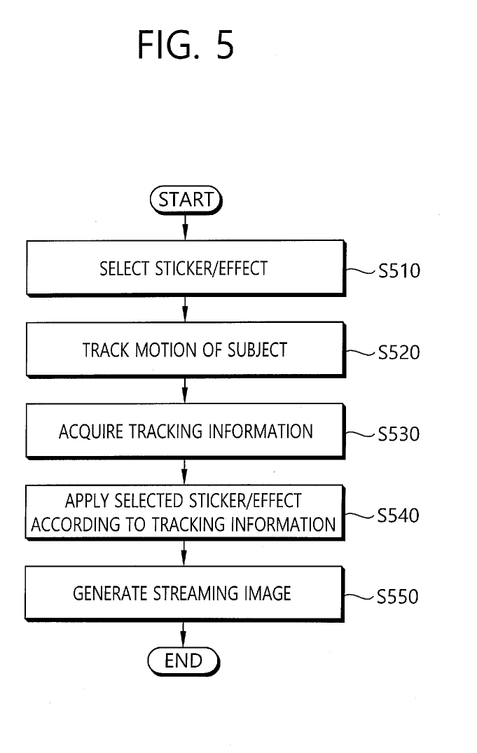

FIG. 5 is a detailed flowchart illustrating a method of generating a streaming image based on tracking information.

Referring to FIG. 5, when the first client terminal selectively applies the sticker/effect, the first client terminal may applies the sticker/effect in a stationary state, but may applies the sticker/effect in a form of moving along a moving subject. To this end, firstly, when a sticker/effect to be applied to the first client terminal is selected (S510), the first client terminal executes the tracking algorithm included in the broadcast platform information to track the movement of the subject (S520). For tracking, the tracking target needs to be first determined, which may be specified based on the target portion to which each sticker is applied. For example, since a cap-shaped sticker is applied to a head portion of the human body, an upper head portion of the face part of a person is determined to a tracking subject through the face tracking. In this manner, when the tracking subjects related to the application parts of each sticker are determined, the feature points of the determined subject are extracted. The extracted feature points may be preset in the tracking algorithm. For example, in a mesh-based face tracking, a point of a preset specific position of a contour based on a mesh of the upper portion is extracted as a feature point. Then, a sticker/effect is applied via the corresponding feature point. Since the movement of the subject means movement of the feature point, the movement path of the feature point is calculated to acquire tracking information (S530). Then, when the selected sticker is applied while moving the selected sticker along the movement path of the feature point of the target subject based on the acquired tracking information, the sticker/effect may also be naturally moved along with the movement of the subject (S540). Thus, a streaming image may be generated based on the sticker applied while tracking the movement (S550).

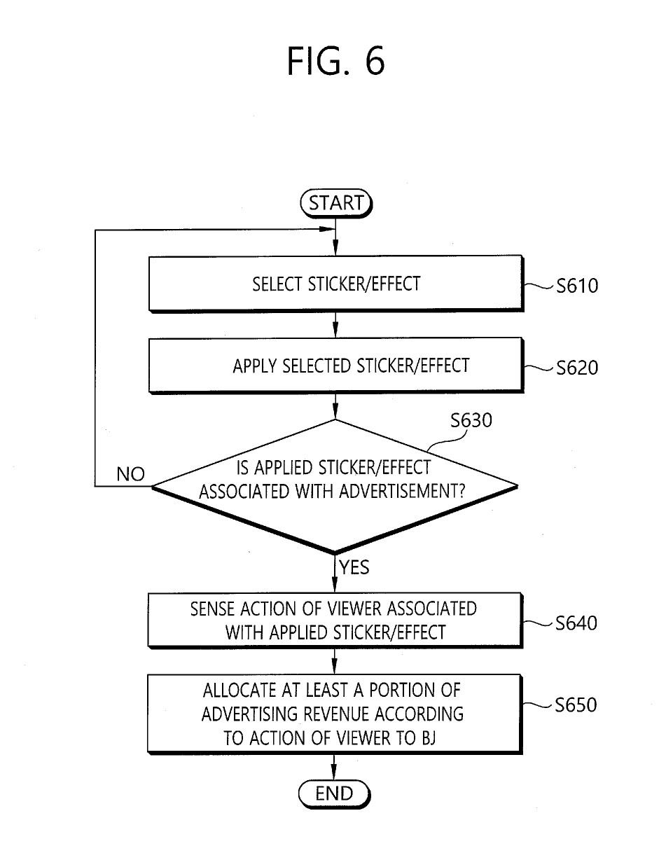

FIG. 6 is a flowchart illustrating a method of applying a sticker associated with an advertisement and sharing an advertising revenue based on the applied sticker.

Referring to FIG. 6, the first client may select a sticker/effect to be applied to the broadcast streaming image (S610), and may apply the sticker/effect (S620).

In this case, it is possible to check whether the applied sticker/effect is in association with the advertisement (S630). The association with the advertisement means that the corresponding sticker may be a sticker created by affiliating with a specific business (e.g., a brand). Accordingly, the sticker may include information about the specific business in association with a product of the specific business. That is, when a sticker is clicked, a linking operation may be performed such as linking to a product or a business site of a business, or replaying an associated advertisement video.

If the sticker/effect is in non-association with the advertisement, since the application of the sticker/effect performs a function of giving a viewer fun by applying the sticker/effect, the purpose of the application of the sticker/effect is achieved. However, if there is an association with the advertisement, the revenue distribution according to the advertisement effect may be additionally considered. The association with the advertisement may be confirmed by parsing the individual feature information of each sticker, and in some cases, flags are assigned such that an advertisement-based sticker/effect is indicated as “1”, and a non-advertisement-based sticker/effect is indicated as “0”.

If the applied sticker/effect is in association with the advertisement, the policy information related to the revenue distribution of the advertisement is parsed. In this case, when the revenue is distributed as the same time as the use of the sticker/effect, a broadcast jockey may acquire a portion of the fee only by using the advertisement-based sticker at the first client terminal. In this case, since the advertisement effect is maximized as the number of viewers who enter the broadcasting station increases, the fee may be set in consideration of the number of viewers who are in the broadcasting station at the time of use of the sticker. For example, in the case of a sticker of “10” points, 100 points may be provided to the broadcast jockey as the fee when there are 10 viewers, and 1000 points may be provided to the broadcast jockey when there are 100 viewers.

However, when the fee is not set at the same time as the use as described above and the fee is set based on the secondary action of a viewer of the corresponding broadcasting station, the action of the viewer terminal associated with the applied sticker/effect is sensed (S640). This may be performed in the server apparatus. When an action such as purchasing a product, touring a product, and adding to a shopping cart is performed through a site linked to the brand of the sticker, a compensation corresponding thereto may be offered to the broadcast jockey in accordance with the types of secondary actions. Alternatively, the fee may be set in consideration of the number of click operations. That is, at least a portion of the advertising revenue calculated through various methods as described above is allocated to an account connected to the account of the broadcast jockey (S650). In other words, the broadcast jockey may be allowed to consider the allocation of these fees as an incentive, and to use the advertisement-based stickers as much as possible at the appropriate time, thereby allowing a business associated with the advertisement to enjoy various advertising effects as well.

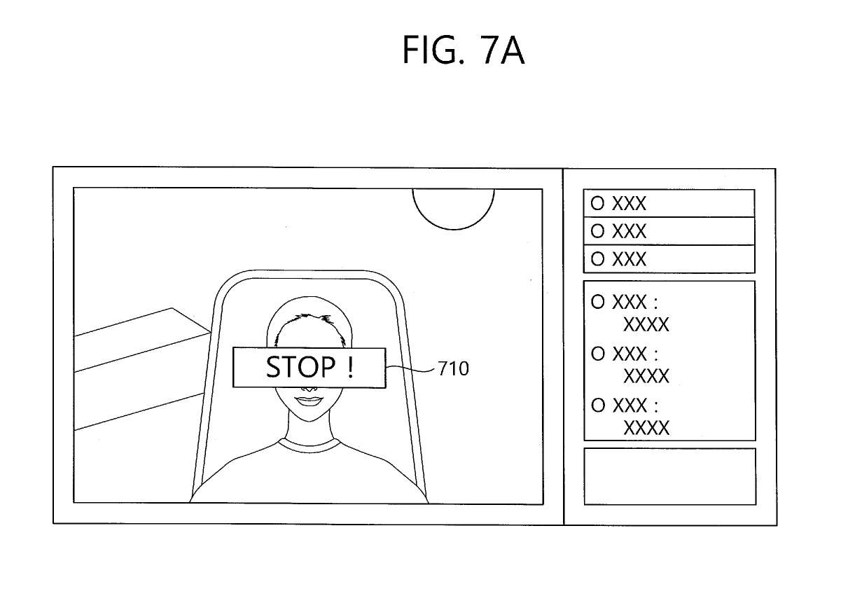

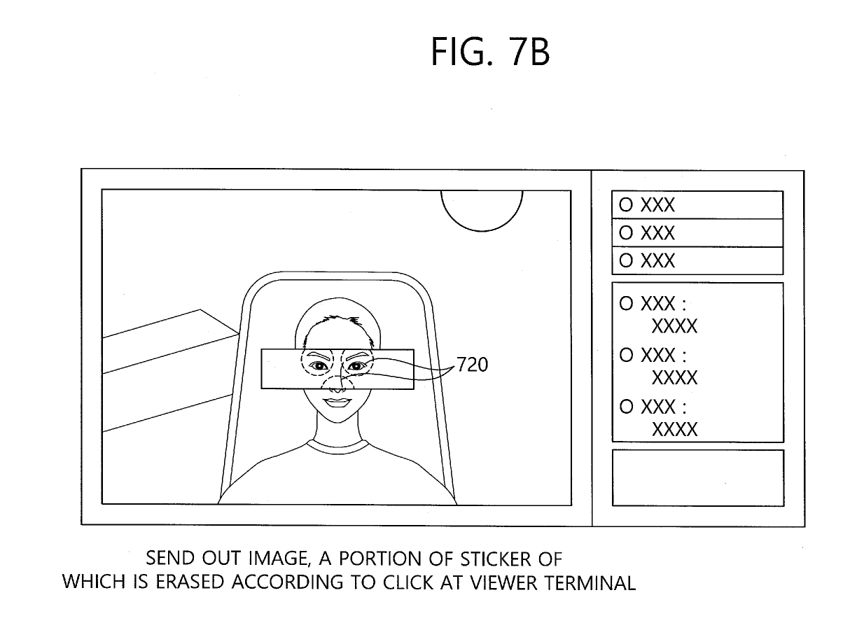

FIGS. 7A and 7B are conceptual views illustrating examples of various kinds of stickers and effects.

Referring to FIG. 7A, a sticker 710 covering a specific part in a streaming image may be utilized. For example, in the case of broadcasting of a broadcast jockey that gives pleasure through make-up, the sticker 710 that covers a portion of the made-up face may be provided. In this case, the first client terminal may determine a position to be covered while directly moving the sticker 710, and the coordinate information of the sticker 710 determined through the first client terminal may be transmitted to the server. In this case, information on the basic streaming image to which the sticker 710 is not applied may also be transmitted to the server.

Referring to FIG. 7B, the sticker 710 covering the specific part is basically for erasing the covered sticker area. However, in this case, since the effect of covering the sticker area is less when the sticker area is erased for all viewers, the sticker 710 may be utilized in a form of allowing a certain area of the sticker 710 to disappear according to clicks according to the cost settlement of a viewer. That is, when a specific viewer performs the cost payment of three times, he/she can click on desired parts to delete portions of the sticker 710 area. In other words, three erased areas 720 can be secured by clicking an eye part 720 and a nose part 720 three times. Since the server apparatus also holds the basic streaming image, this may be performed by replacing only the sticker areas of the corresponding parts with the basic streaming image. Alternatively, a sticker 710 may be created on the basic streaming image in the server apparatus, and may be placed on a subject. Thereafter, a portion of the sticker 710 placed on the subject may be erased. In this case, the size of the erased area and the click cost for the erased area may be determined by the broadcast jockey and/or the server. Also, a sticker of a form in which a portion of the face covered with a sticker is changed to that of another person's face and the changed face is sent out may be applied. When a face change sticker is applied to a face portion of a subject of the first client terminal, a menu for selecting the face of another person to be applied is displayed. Through the menu, a user of the first client terminal may select a photograph or an image of another person, and tracks and extracts the face portion of another person from the selected photograph or the image. Then, the face portion of the position where the face change sticker exists may be deleted, and may be changed into the extracted face of another person. Alternatively, a sticker of another person's face type may be provided in advance in the menu, and may be directly changed into the face of the corresponding sticker.

Based on these functions, each viewer may acquire different streaming images through different number of times being clicked. This may induce viewers to spend money, and may allow the spent cost to flow to the broadcast jockey (allowing the service provider to acquire a portion of fee in the server apparatus), thereby having an effect of giving the broadcast jockey an incentive for making the broadcasting more enjoyable.

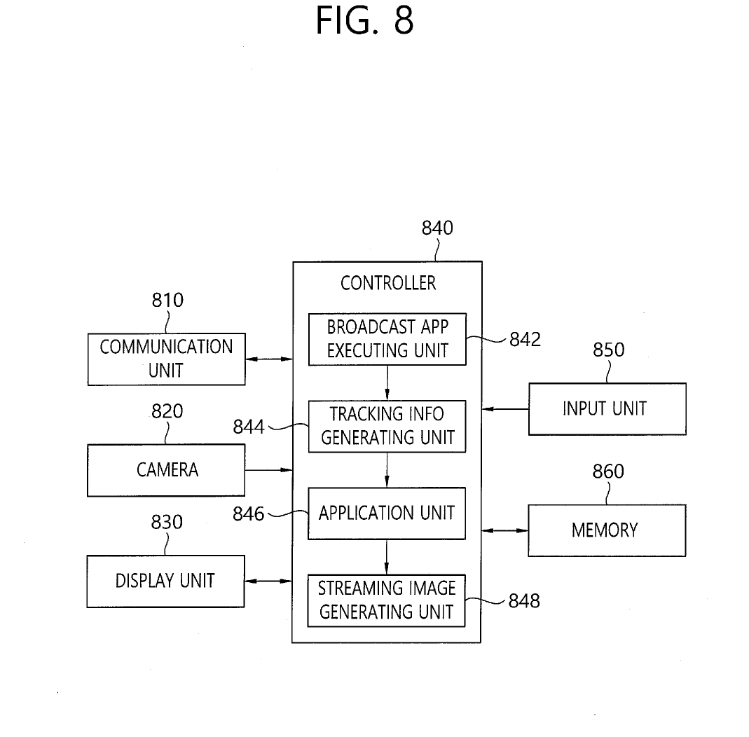

FIG. 8 is a view illustrating a live streaming image generating apparatus according to an embodiment of the present invention. As shown in FIG. 8, a live streaming image generating apparatus according to an embodiment of the present invention may include a communication unit 810, a camera 820, a display unit 830, a controller 840, an input unit 850, and a memory 860.

Referring to FIG. 8, the communication unit 810 has a function of performing communication with a server apparatus and other apparatuses. The communication unit 810 includes equipment for wireless or wired communication. For example, the communication unit 810 may include an antenna and/or a communication processor.

The camera 820 is a device for photographing a subject, and an image photographed through the camera 820 is processed in the controller 840. The camera 820 may be present in the live broadcasting streaming image generating apparatus, or may be connected to the outside through an interface such as a High-Definition Multimedia Interface (HDMI).

The display unit 830 outputs the image processed through the controller 830. The display unit 830 may be implemented as a monitor, a touch screen, a TV receiver, or the like.

The controller 840 may include a broadcast application executing unit 842, a tracking information generating unit 844, an application unit 846, and a streaming image generating unit 848.

The broadcast application executing unit 842 installs and executes an application/program associated with the streaming based on the platform information received through the communication unit 810. In the case of broadcast streaming, the broadcast application executing unit 842 installs a broadcast application/program on the basis of the broadcast platform information, and executes the broadcast application/program by an input through the input unit 850. In this case, a program entry operation such as login may be performed.

The tracking information generating unit 844 generates tracking information according to the tracking algorithm included in the platform information and provides the tracking information to the application unit 846.

The application unit 846 performs a function of applying a sticker/effect. The application unit 846 outputs a set of appropriate sticker/effects through the display unit 830 based on at least one of the account of a user of the first client terminal that enters the broadcast application/program, the IP of the first client terminal, and the broadcast service contents and type. Then, the application unit 846 receives an input related to a user's selection through the input unit 850, and applies the selected sticker/effect to one area of the target subject or the display screen (first streaming image). In this case, the sticker/effect may be applied along the movement of the subject based on the tracking information.

The streaming image generating unit 848 processes the image photographed through the camera 820 to generate a basic streaming image. Here, encoding and decoding may be performed. Also, when the sticker/effect is applied, processing of the second streaming image to which the sticker/effect is applied may also be performed.

The input unit 850 is an interface for processing a user input such as a keyboard, a mouse, and a touch pad.

The memory 860 stores instructions (or directives) related to each function performed in the controller 840. The memory 860 includes instructions based on the broadcast platform information, and may store information received from the server apparatus or other devices through the communication unit 810.

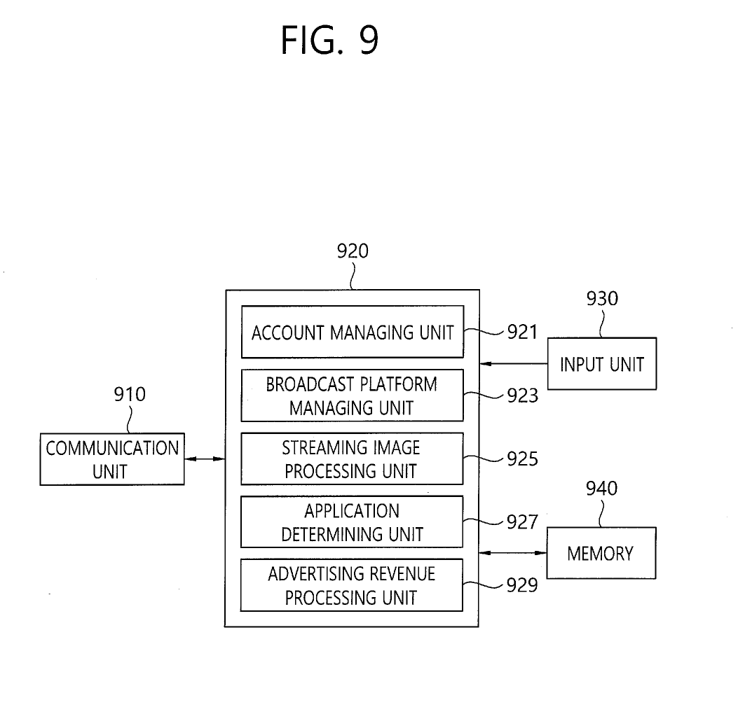

FIG. 9 is a view illustrating a live streaming image providing apparatus according to an embodiment of the present invention. As shown in FIG. 9, the live streaming image providing apparatus according to an embodiment of the present invention may include a communication unit 910, a controller 920, an input unit 930, and a memory 940.

The communication unit 910 is a device responsible for communication with the first client terminal and the second client terminal.

The controller 920, which is an element for managing and controlling an application, may include an account managing unit 921, a broadcast platform managing unit 923, a streaming image processing unit 925, an application determining unit 927, and an advertising revenue processing unit 929.

The account managing unit 921 manages information related to an account that logs into an application (e.g., a broadcast application). The account managing unit 921 may manage the personal history of each account as well as the history of broadcasting performed through each account. For example, the account managing unit 921 may manage information such as a broadcasting station opening time, an opening format, a handling content, and a service type opened through a specific user account, information related to admission to a broadcasting station opened by another user, and/or history of stickers/effects that are selected and applied.

The broadcast platform managing unit 923 manages the platform information (including broadcast platform information) of FIG. 4. This includes periodic upgrade of software and generation of customized sticker/effect sets according to broadcast-related use history of a user.

The streaming image processing unit 925 processes the first streaming image and/or the second streaming image received from the first client terminal. The streaming image processing unit 925 may together receive basic streaming information (first streaming image) to which the sticker/effect is not applied from the first client terminal and streaming image (second streaming image) to which the sticker/effect is applied, and may independently process these first and second streaming images. For example, when the basic streaming image information is received, a signal associated with a request for applying a specific sticker may be received, and the received signal may be parsed, thereby applying the requested sticker to the basic streaming image and directly generating a streaming image to which a sticker is applied.

Also, the streaming image processing unit 925 individually processes a request associated with a sticker from the second client terminal to perform image processing such that different streaming images can be viewed in regard to the area of the sticker in different terminals.

The application determining unit 927 determines whether or not the sticker is applied, and whether or not the sticker for advertisement is applied. In the case of a sticker for advertisement, it is determined which business (or brand) is associated.

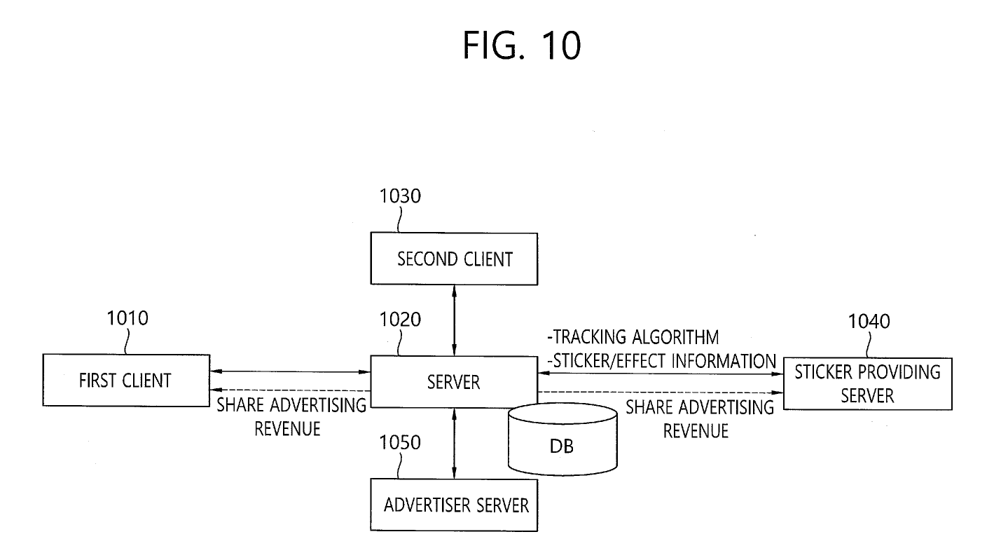

The advertising revenue processing unit 929 distributes advertising revenue associated with the sticker. In particular, in the case of a sticker for advertisement, the advertising revenue processing unit 929 may detect arbitrary actions of viewers (viewers admitted to the corresponding broadcasting station) who view the advertising sticker detects an arbitrary action linked to the corresponding brand, and may share a revenue according to the advertisement sales with a broadcast jockey and a live broadcast service providing server (and/or a sticker providing server (see FIG. 10)). In this case, a Cost Per Click (CPC) method, a Pay Per Click (PPC) method, a Cost Per Time (CPT) method, a Cost Per Mile (CPM) method, a Cost Per Millenium (CPM) method, a Cost Per Impression (CPI) method, and a Cost Per Conversion (CPCon) method regarding links related to the advertising sticker may be utilized for the distribution of advertising revenue.

The input unit 930 is an interface for processing user inputs for changing various user settings associated with the broadcast application.

The memory 940 stores instructions related to each function performed by the controller 920. For example, the memory may include user history information associated with the account, use history information of the sticker, information of the sticker itself (information on whether it is a sticker for advertisement and which business and which link is associated with the sticker for advertisement).

FIG. 10 is a view illustrating a live streaming system according to another embodiment of the present invention. As shown in FIG. 10, a live streaming system according to another embodiment of the present invention may include a first client terminal 1010, a server 1020, a second client terminal 1030, a sticker providing server 1040, and an advertiser server 1050.

Referring to FIG. 10, operations of the first client terminal 1010, the server 1020, and the second client terminal 1030 are similar to those described above.

The sticker providing server 1040 may provide a face tracking development Software Development Kits (SDKs) to the live broadcasting server 1020, and may apply SDKs to app clients 1010 and 1030 or the web of the live broadcasting service. Then, the first client terminal 1010 opens a sticker inventory to a broadcast service used by a broadcast jockey, such that at least one of SDKs can be selectively used. For various live broadcasting services, various stickers stored in a sticker archive of the sticker providing server 1040 may be provided at the same time.

The sticker providing server 1040 may provide and operate stickers to media desired by advertisers like an ad network. Also, in addition to the advertising sticker (brand-affiliated sticker), the contents such as the background sound sources, the professional effects, the subtitle functions, and the intermediate advertisement used for broadcasting may be provided in real-time. The server 1030 may provide such information to the client terminals 1010 and 1030.

In order to implement this operation, the sticker providing server 1040 provides the face tracking SDK and the user use tracker to the live broadcasting server 1030, and the live broadcasting server 1030 transmits information related to the user use data and the function promotion to the sticker providing server 1040. Then, both may together share advertising revenue.

As described above, the sticker may be applied to both the web and the mobile environment, and the broadcast jockey may maximize the fun of broadcasting by displaying a screen on which a sticker is applied to a viewer who watches broadcasting on his/her broadcasting station. In particular, when a brand-affiliated sticker is utilized, viewers who view the brand-affiliated sticker sense any action that is linked to the corresponding brand, and thus a revenue according to the advertisement sales may be shared by broadcast jockey, a live broadcasting service provider (i.e., server 1020), and the sticker providing server 1040. In this case, a Cost Per Click (CPC) method, a Pay Per Click (PPC) method, a Cost Per Time (CPT) method, a Cost Per Mile (CPM) method, a Cost Per Millenium (CPM) method, a Cost Per Impression (CPI) method, and a Cost Per Conversion (CPCon) method regarding links related to the brand-affiliated sticker may be considered for the distribution of advertising revenue.

According to another embodiment of the present invention, when distributing the advertising revenue, the server apparatus may also distribute the revenue to accounts related to the broadcast performers appearing on the broadcasting through the first client terminal and/or accounts of the broadcast viewers. That is, when the advertising sticker is used for the broadcast performers, the information on the broadcast performer to which the sticker is applied may be acquired, and a portion of the advertising revenue may be distributed to the accounts associated with the acquired information. Also, when a viewer watches the advertising sticker of the streaming image, the viewer may leave a log and share a portion of the advertising revenue.

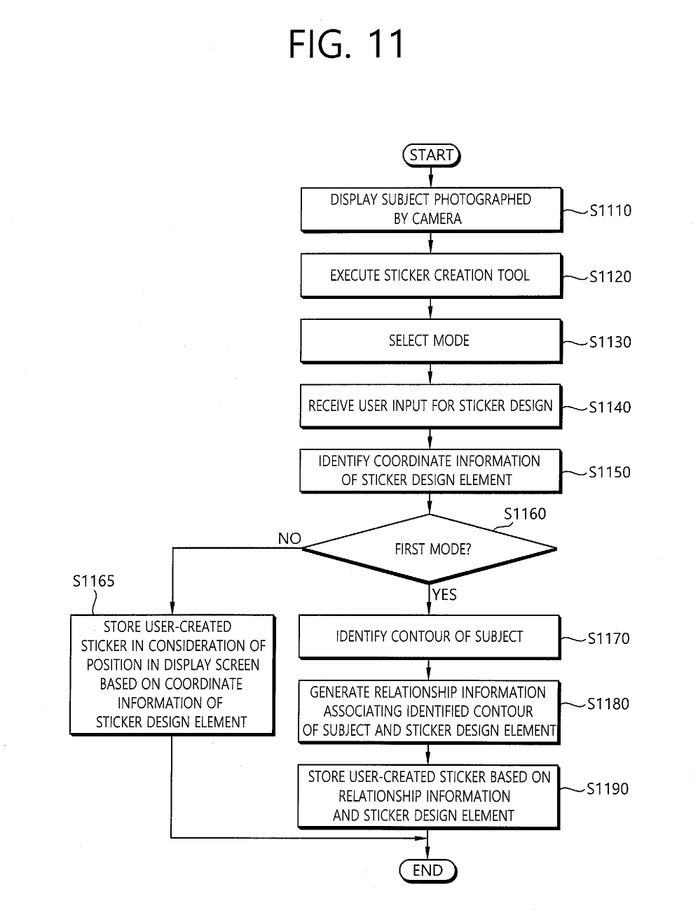

FIG. 11 is a flowchart illustrating a method of generating a streaming image based on a sticker created directly by a user in a live streaming image generating apparatus according to an embodiment of the present invention.

Referring to FIG. 11, a client terminal executes an application related to broadcasting and displays a subject photographed by a camera (S1110). Then, a sticker/effect application menu starts, and a sticker creation tool is executed in the corresponding menu (S1120). The sticker creation tool may be provided as one function of sticker/effect application menu of the broad application. When a user selects the sticker creation tool, the terminal displays a menu for sticker creation on the display screen. According to another embodiment of the present invention, a sticker may be created using photographs or videos previously stored in the terminal, not during photographing.

Next, a mode for sticker creation is selected (S1130). Here, the mode for creation may include two modes, i.e., a first mode and a second mode.

The first mode is a mode for recognizing a subject such as a face, and associates a sticker design element generated by a user input with at least one of displayed subjects. In this case, the contour of the subject may be considered as an element determining the relationship with the sticker design element. The contour of the subject may be identified using pre-stored edge templates. For example, when a subject is a face, edge templates including the overall layout information of a plurality of components such as eyes, nose, and mouth in the face are stored in advance, and the contour of the face and the contours of the components in the face displayed on the displayed screen are matched with the pre-stored edge templates to first recognize the face and identify and store the contour information of the recognized face. In this case, information such as brightness, motion, color, and eye position estimation may be used to distinguish the face and the background. In this case, it is effective to analyze the main part of the face, discard the fine error, capture only the large feature, and compare with the stored face template. In the embodiment of the present invention, the edge template is not necessarily related to the face, but may be related to other parts of the human body such as arms, legs, hands, and the like.

In the first mode, due to the association with the subject, the sticker design element generated by a user in response to a motion of the subject and/or a change in the size of the subject may also move and change in size.

The second mode is a mode for designing to display a subject at a specific position on the display screen in consideration of the association with the displayed screen instead of the association with the subject. In the second mode, the sticker design element may be displayed at a fixed size at a predetermined position in the display screen without being affected by the motion of a subject. In some cases, in the second mode, a moving effect such as a change in size may also be given according to the setting of the user.

When the mode selection is completed, a user receives a user input for the sticker design through a user interface (e.g., a touch screen, a keyboard, a mouse, etc.) (S1140). The user input for the sticker design may be a text input, and may be an input through a drawing mode. The drawing mode may be referred to as a doodling mode. A sticker design element may be created by inputting a text input through typing using a keyboard, and a sticker may be created by inputting a line or a figure selected by a user through a mouse or a touch screen in a drawing mode.

According to an embodiment of the present invention, figures and images may be imported in addition to the text and drawings. The figures may include a still figure, an animation graphic, or a 3D subject, and the images may be imported from a camera or album and may be used as a sticker design element. The figures may include solid lines, triangles, squares, arrows, bent lines, half-moon shapes, clouds, hearts, mathematical expression-related figures, flowchart-related figure, and the like. These figures may be stored in a template in advance.

According to another embodiment of the present invention, other effects such as a sound and a functional figure capable of calling a specific animation may be utilized as sticker design elements.

The client terminal identifies in-screen coordinate information of each sticker design element to memorize the inputted sticker design element as a user-created sticker (S1150). The coordinate information is recognized by identifying the coordinates of pixels related to the sticker design element in the displayed screen. The identified coordinate information may be utilized as relationship information indicating an association with a display screen or a subject in accordance with a mode selected by a user.

After identifying the coordinates of the inputted sticker design element, it is determined whether the mode is the first mode or the second mode (S1160). The first mode (subject recognition mode) is allowed to have an association with the contour of the subject, and the second mode is allowed to have an association with the display screen. The switching between the first mode and the second mode is possible at any time before the sticker is stored. Accordingly, upon sensing of a mode change, all of the sticker design elements interpreted with the second mode may be interpreted with the first mode. That is, the sticker design elements analyzed through operation S1165 may be interpreted through operations S1170 to S1190, and vice versa.

If the first mode is selected in operation S1160, first, the contour of a subject is identified using the edge template (S1170). The terminal stores a figure (e.g., a rectangle) including all the sticker design elements as an image, and recognizes a subject in the stored image to identify the contour of the identified subject. In this case, there may be a plurality of subjects in the image. For example, the face may be a subject, and other parts of a person such as hand and arm may be a subject. The client terminal recognizes a subject based on a pre-stored edge template of the subject, and identifies the contour of the subject. In this case, coordinate information of the pixel related to the contour can be checked.

Then, relationship information for associating the contour of the identified subject with the sticker design element is generated based on the coordinate information of the sticker design element identified in operation S1150 (S1180). According to an embodiment of the present invention, the center point of the subject is searched based on the contour of the subject included in the stored image. Then, based on the distance from the center point to the contour of the subject, the relationship between the sticker design element and the subject may be grasped by considering the distance from the contour of the subject or the center point to the sticker design element. Then, the relationship information may be generated based on the grasped relationship.

According to another embodiment, in operation S1180, a point corresponding to the synchronization point is searched on the pre-stored edge template. The synchronization point, which is a point for synchronizing the contour of the actual subject currently displayed, the sticker design element and the pre-stored edge template, may be specified as a specific point on the contour of the subject. For example, a specific point on the contour of the subject having an association with the end of the sticker design element becomes a synchronization point. Alternatively, the start point and/or the end point of the sticker design element and the nearest point on the contour may become synchronization points. In some cases, a point at which the sticker design element and the contour meet each other may become a synchronization point. Thus, there are various algorithms for determining the synchronization point, and this may be received while being included in broadcast platform information received from the server apparatus. The synchronization point on the contour of the actual subject corresponds to a specific point on the edge template that is matched with the subject, and based thereon, may be appropriately applied to another subject to which the edge template is applied. The generated synchronization point may be considered as the relationship information.

When the relationship information is generated, the client terminal stores a user-created sticker in a local area based on the relationship information and the sticker design element (S1190). In this case, a user may instruct to perform storage by pressing a storage icon. That is, if it is determined that a user has created a preferred sticker to such an extent as to register as a sticker while creating user-created stickers as a fun factor through the process from operation S1110 to operation S1180, the user may register and save the sticker that is currently being implemented. That is, the storage of the sticker may also be selectively determined according to the preference of a broadcast jockey. Then, the stored user creation information and the streaming image to which the user creation sticker is applied are transmitted to the server apparatus. The server apparatus that receives the information and the image may broadcast the streaming image to which the user creation sticker is applied to a viewer client.

In this case, the sticker-related information that is stored and transmitted may include the relationship information, the information on the contour of the subject and each sticker design element coordinates, and the information on the sticker design element itself. Alternatively, related edge template information may be further stored. In this case, the relationship information may include synchronization point information (e.g., a specific point on the subject or a point on the edge template corresponding to the specific point) and information (e.g., distance information, etc.) indicating a relationship between the synchronization point and the sticker design element. The information on the sticker design element itself may include the type of the sticker design element (whether the sticker design element is text or drawing), and in case of drawing, may include information on the color, thickness, shape, etc. of the line forming the sticker design element.

If the second mode is selected in operation S1160, the procedure enters the second mode, and a user-created sticker is created and stored in consideration of the position in the display screen based on the coordinate information of the sticker design element (S1165). In this case, information related to the subject is not stored, and only the coordinate information in the display screen may be stored for association with the display screen.

Since the subject may continue to move and change in size during the photographing except a case where pre-stored pictures are used, the time point at which the contour of the subject and the pixel coordinates of the sticker design element are identified may be important. According to an embodiment of the present invention, the time point at which the contour of the subject and the coordinates of the sticker design element are identified may include a time point at which a user input for creating a sticker design element starts or a time point at which a user input is completed. The subject and the sticker design element are identified in accordance with the corresponding time point, and the sticker design element also changes corresponding to the change of the subject after the corresponding time point.

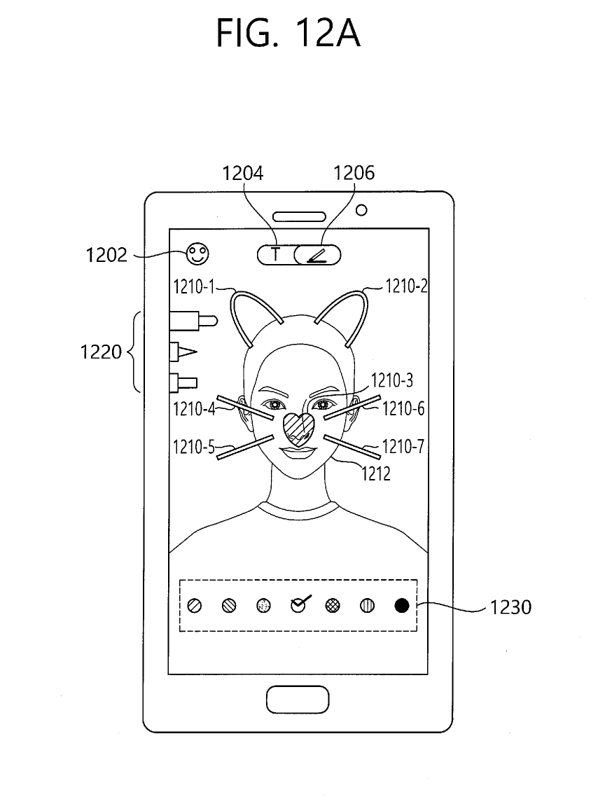

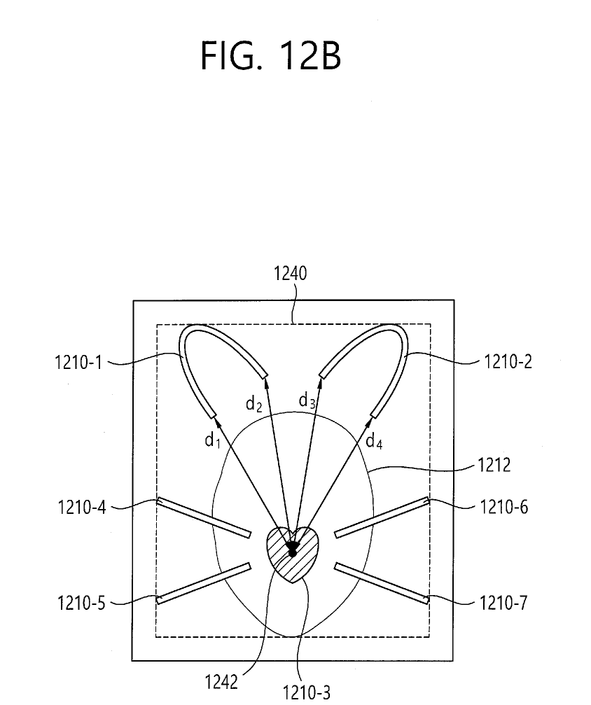

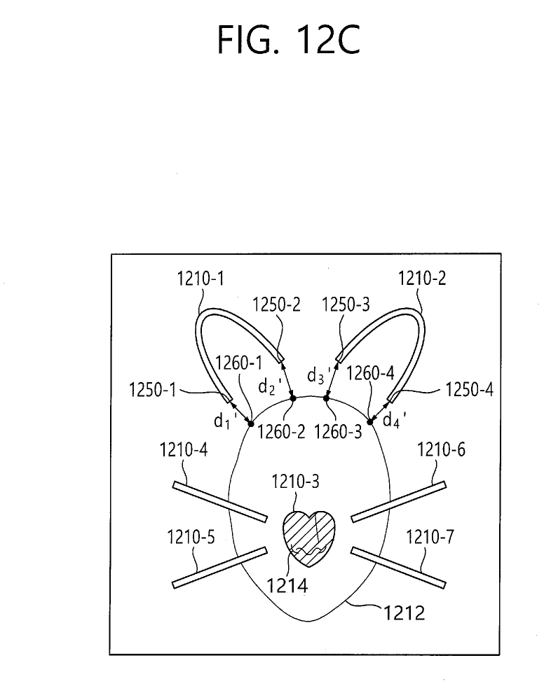

FIG. 12A is a view illustrating a screen of an actual application for implementing a sticker created by a user.

Referring to FIG. 12A, a tool for creating a user creation sticker includes an icon 1202 for selecting a first mode and a second mode at the top of a broadcast screen, icons 1204 and 1206 for selecting a type of a sticker design element. When the icon 1202 is pressed, the first mode is operated and the sticker moves in conjunction with the contour of the subject. When the icon 1202 is not pressed, the contour of the subject is not recognized because there is no association operation with the subject. The embodiment of FIG. 12A assumes a situation where the first mode is selected.

Also, when the icon 1204 is selected, a text input is possible, and when the icon 1206 is selected, the user input of the drawing mode is possible. The embodiment of FIG. 12A assumes a situation where the drawing mode is selected.

In the drawing mode, a user may select the thickness and shape of a line through a menu 1220 for selecting a basic line for drawing on the left side of the screen. A user may arbitrarily change the thickness and shape of the line using the menu 1220 during the drawing. For example, in regard to the thickness of line, a menu for selecting a plurality of thicknesses from the thickest line at the top to the thinnest line at the bottom may be provided. In addition, a menu (a menu for selecting a pen type or a brush type) for selecting the shape of line may include options such as a triangular shape line, a rectangular shape line, a circular shape line, a heart shape line, a two-colored line, a line with a solid effect, a line with a shadow effect, and the like.

Also, a menu 1230 for selecting a line color may be provided at the bottom of the screen. A user may perform drawing by selecting one of a plurality of provided colors.

In the embodiment of FIG. 12A, a user is photographing the upper body of the human body including the face, and a client terminal displays the same. The broadcast jockey generates a plurality of sticker design elements 1210-1 to 1210-7 by performing drawing with the thickness, shape, and color of the line selected through the menu 1220 and the menu 1230 during photographing in real-time. Different lines may be used through the menu 1220 and menu 1230 whenever there are inputs for each of the sticker design elements 1210-1 to 1210-7. On the whole, the sticker design elements 1210-1 and 1210-2 are formed at the top of the face to form a rabbit ear shape. The sticker design element 1210-3 is formed in the shape of a heart around the nose, and the sticker design elements 1210-4 to 1210-7 form a whisker shape diverging around the nose.

Hereinafter, a method of recognizing these sticker design elements 1210-1 to 1210-7 and storing the whole user creation sticker by the client terminal will be described. The client terminal individually recognizes the sticker design elements 1210-4 to 1210-7 and associates each sticker design element with the subjects. That is, the subjects associated with the sticker design elements 1210-4 through 1210-7 may be different. The sticker design element may be recognized as a figure formed of one connected line, or as a text unit typed at a time.

FIG. 12B is a conceptual view illustrating a first embodiment of associating a subject with a sticker design element displayed on the screen of FIG. 12A.

Referring to FIG. 12B, when a sticker design element is created by a user input, a terminal stores a FIG. 1240 including all the sticker design elements in an image form. Then, a subject included in a graphic form 1240 is identified. In the embodiment of FIG. 12B, the face may be identified as a subject in an image. In this case, the subject is recognized as a face by matching the contour of the subject and the previously stored face templates, and the face contour information may be acquired based on the recognized face. When the face contour is acquired, the coordinates of the center point 1242 of the face may be secured based on the face contour information. Then, based on the relationship between the coordinates of the face center point 1242 and the contour of the face, relationship information between the subject (face) and the respective sticker design elements 1210-1 to 1210-7 is generated. For example, the relationship between the distance from the face center point 1242 and the face contour and the distances (including d1, d2, d3, d4) between the face center point 1242 and each of the sticker design elements 1210-1 to 1210-7 may be generated as the relationship information. Alternatively the distances between the face contour and each of the sticker design elements 1210-1 to 1210-7 may be considered as the relationship information. It may be desirable to consider the starting and ending points of each of the sticker design elements 1210-1 to 1210-7 when calculating the distances to each of the sticker design elements 1210-1 to 1210-7.

Based on the generated relationship information, since the distance between the center point and the contour of the face is changed when the face contour is changed (e.g., the shape of the face changes or the size of the face changes), the distances to each of the sticker design elements 1210-1 to 1210-7 may also be changed.

FIG. 12C is a conceptual view illustrating a second embodiment of associating a subject with sticker design elements displayed on the screen of FIG. 12A.

Referring to FIG. 12C, a sticker design element 1210-1 starts inputting at a start point 1250-1, and ends inputting at an end point 1250-2. The client terminal may recognize the start point 1250-1 and end point 1250-2, and may identify a subject to be associated. In this embodiment, the “face” closest to the sticker design element 1210-1 and having a high matching degree is selected as a subject to be associated. In this case, the subject is recognized as the face by matching the contour of the subject with the pre-stored face template, and information on the face contour 1212 may be obtained based on the recognized face. The client terminal searches for a synchronization point to clarify the relationship with the subject, i.e., the face contour 1212, which is associated with the sticker design element 1210-1. The synchronization point, which is a point on the face contour 1212, may preferably have a specific relationship with the start point 1250-1 and the end point 1250-2. For example, the nearest point from the start point 1250-1 and the end point 1250-2 may be preferable. Alternatively, a point on the contour 1212 which meets the sticker design element 1210-1 may become a synchronization point. The information related to the synchronization point includes coordinate information indicating a point on the contour of the subject, and the information related to the synchronization point also becomes information stored in the terminal when the user-created sticker is stored.

In this embodiment, points 1260-1 and 1260-2, which are points on the face contour 1212 closest to the start point 1250-1 and the end point 1250-2, may be detected as the synchronization points.

After the client terminal detects the synchronization points 1260-1 and 1260-2, the client terminal calculates distances d1′ and d2′ between the face contour 1212 and the start point 1250-1 and the end point 1250-2, and stores the distances d1′ and d2′ as relationship information. That is, even if applied to another face, the created sticker may be reproduced in such a manner that the sticker design element is created at the distances d1 ‘and d2’ away from the synchronization points. In this case, if the size of the face changes, the distances d1′ and d2′ may also be reduced or increased in proportion to the changed size. That is, even if the shape or scale of the face is changed, the sticker design element may be appropriately applied by searching for the coordinates corresponding to the coordinates of the synchronization points of the current face from the changed face.

In addition, the shape and scale of the sticker design element may be appropriately resized by identifying the coordinates of the whole pixels, on which the sticker design elements are displayed, to recognize and store the shape and by responding to changes in the size and shape (tilt, etc.) of the subject later. For example, when the size of the subject is changed, the size as well as the coordinates of the synchronization point may also be changed so as to correspond to the size of the changed subject while maintaining the shape of the sticker design element.

Next, in the case of the sticker design element 1210-3, the relationship with the face contour 1212 may also be considered, but the relationship with the nose contour 1214 is also considered. Accordingly, in this case, a plurality of synchronization points may be detected with respect to the contours 1212 and 1214 of a plurality of subjects, and relationship information with the detected plurality of synchronization points may be generated and stored.

According to another embodiment of the present invention, a sticker design element that covers the whole of the face may be created. In this case, considering the relationship with the face contour 1212, when the face is displayed small, the size of the sticker design element also becomes small enough to cover the reduced face, and when the face is displayed large, the size of the sticker design element also becomes large enough to cover the enlarged face. The size and shape of such a sticker design element and the position change of the synchronization points may be automatically changed in response to a change in the size and shape of the subject being photographed in real-time.

The tracking method based on the relationship information of the subject and the sticker design elements according to an embodiment, which has been described in FIGS. 12A to 12C, is applicable to tracking of a previously stored sticker and a subject. Also, information related to the user creation sticker generated and stored according to the above embodiment may be provided to the server apparatus together with the streaming image.

According to another embodiment of the present invention, in a method of providing a live broadcasting service, a server stores a hash tag for a sticker applied to a streaming image in a database, and automatically applies the hash tag stored in the database at a time of sharing the corresponding image. Thus, it is possible to easily retrieve the image to which an advertising sticker is applied, thereby estimating the use frequency or the exposure frequency of the advertising sticker. Naturally, a watermark for the corresponding sticker may be inserted into the sticker according to an embodiment of the present invention, and the use frequency of the sticker may also be estimated using the inserted watermark code.

Although the present invention has been described with reference to the drawings and embodiments, it can be understood that the scope of protection of the present invention is not limited by the drawings and embodiments, and it will be understood by those skilled in the art that various modifications and changes can be made without departing from the spirit and scope of the present invention described in the appended claims.

According to the live streaming image generating method and apparatus, the live streaming service providing method and apparatus, and the live streaming system of the present invention, an additional profit can be created by utilizing a brand-affiliated sticker through live broadcasting.

Also, advertisement sales from various brands and advertisers who want to advertise through live broadcasting are effectively shared by a live broadcasting provider, BJ, and a sticker provider.

What is claimed is:

1. A method for generating a live streaming image in a client terminal, the method comprising:
acquiring platform information for generating a streaming image;
generating a first streaming image based on the platform information;
displaying the first streaming image;
selecting, by a user input, at least one of stickers and effects for decorating at least a portion of the displayed first streaming image; and
generating a second streaming image by applying the selected at least one of the stickers and effects to the first streaming image in real-time.

2. The method of claim 1, wherein the generating of the first streaming image comprises:
photographing a subject through a camera; and
generating the first streaming image based on the photographed subject.

3. The method of claim 2, wherein the generating of the second streaming image comprises:
tracking the subject in real-time to acquire tracking information; and
generating the second streaming image by applying the selected at least one of the stickers and effects to the subject based on the acquired tracking information.

4. The method of claim 3, wherein the tracking information comprises information associated with at least one feature point of the subject, and
the selected at least one of the stickers and effects is applied to the subject via the at least one feature point comprised in the tracking information.

5. The method of claim 4, wherein the information associated with the at least one feature point comprises motion information of the at least one feature point, and
the selected at least one of the stickers and effects is applied to the subject in response to a motion of the subject based on the motion information of the at least one feature point.

6. The method of claim 1, further comprising transmitting the generated second streaming image to a live broadcasting server providing a service associated with live broadcasting,
wherein the second streaming image transmitted to the live broadcasting server is transmitted to a client terminal of a viewer who watches the live broadcasting.

7. The method of claim 1, wherein the platform information comprises broadcast platform information associated with live broadcasting acquired from a live broadcasting server providing a service associated with the live broadcasting, and
the acquired broadcast platform information comprises information on at least one of the stickers and the effects.

8. The method of claim 1, wherein the sticker comprises a sticker that arbitrarily sets position information in the first streaming image according to a user input to cover a portion of the first streaming image.

9. The method of claim 1, wherein the effect comprises an effect of allowing at least a portion of the sticker previously applied to the first streaming image to disappear by a user input.

10. A apparatus of generating a live streaming image, the apparatus comprising:
a communication unit for communicating with a server;
a display unit for displaying a first streaming image generated based on platform information for generating a streaming image acquired from the server through the communication unit; and
a controller selecting at least one of stickers and effects for decorating at least a portion of the displayed first streaming image and generating a second streaming image by applying the selected at least one of the stickers and effects to the first streaming image in real-time by a user input.

11. A method for providing a live streaming service in a server apparatus providing a live streaming service, the method comprising:
providing platform information associated with live streaming to a first client terminal;
receiving a second streaming image, in which at least one of stickers and effects for decorating at least a portion of the first streaming image generated based on the platform information is applied in real-time, from the first client terminal; and
providing the second streaming image acquired from the first client terminal to a second client terminal.

12. The method of claim 11, wherein the platform information comprises information about at least one of stickers and effects.

13. The method of claim 11, wherein the live streaming service comprises a live broadcasting service based on the first client terminal, and
the second client terminal is a terminal associated with a viewer who enters a broadcasting station established by the first client terminal.

14. The method of claim 11, wherein at least one of a user input at the first client terminal for applying the sticker and a user input at the second client terminal for activating an effect of allowing at least portion of the applied stickers to disappear is associated with cost payment from at least one of a user account associated with the first client terminal and a user account associated with the second client terminal to the server apparatus.

15. The method of claim 11, wherein the at least one of the stickers and the effects comprises at least one of stickers and effects associated with advertisement.

16. The method of claim 15, when sensing that a user associated with the second client terminal performs an arbitrary action associated with the advertisement based on at least one of stickers and effects associated with the advertisement applied to the streaming image when generating, in the first client terminal, the streaming image by applying at least one of the stickers and effects associated with the advertisement, further comprising:
checking advertising-related information corresponding to at least one of the stickers and effects associated with the advertisement applied to the streaming image, and
sharing at least a portion of a revenue associated with the advertisement with a user associated with at least one of the first client terminal and the second client terminal based on the confirmed advertisement-related information.

17. The method of claim 16, wherein the sharing of revenue associated with the advertisement is performed by estimating the number of times of application of at least one of stickers and effects associated with an advertisement applied to the second streaming image.

18. The method of claim 11, further comprising providing a sticker/effect selection menu comprising at least one of sticker candidates and effect candidates applicable at the first client terminal based on the platform information.

19. The method of claim 18, wherein at least one of the sticker candidates and the effect candidates comprised in the sticker/effect selection menu considers at least one of a history, a content, and a service type of a user associated with the first client terminal and comprises at least one of sticker candidates and effect candidates corresponding thereto.

20. An apparatus for providing a live streaming service, the apparatus comprising:
a communication unit for communicating with a first client terminal and a second client terminal; and
a controller for transmitting platform information associated with live streaming provided to the first client terminal through the communication unit, and receiving, from the first client terminal, a second streaming image to which at least one of stickers and effects for decorating at least a portion of the first streaming image generated based on the platform information to provide the second streaming image acquired from the first client terminal to the second client terminal.
